(19) United States
(12) Patent Application Publication
(10) Pub. No.: US 2015/0227276 A1
(43) Pub. Date: Aug. 13, 2015

(54) METHOD AND SYSTEM FOR PROVIDING AN INTERACTIVE USER GUIDE ON A WEBPAGE

(71) Applicant: Quicko Technosoft Labs Private Limited, Bangalore (IN)

(72) Inventors: Khadim Batti, Bangalore (IN); Maruthi Priya Kanyaka Vara Kumar Namburu, Bangalore (IN)

(21) Appl. No.: 14/617,600

(22) Filed: Feb. 9, 2015

(30) Foreign Application Priority Data
Feb. 10, 2014 (IN) 622/CHE/2014

(51) Int. Cl. G06F 3/0484; G06F 17/22; H04L 29/06

(52) U.S. Cl. CPC G06F 3/0484; H04L 67/42; G06F 17/2247

(57) ABSTRACT

A method and system for providing an interactive user guide on a webpage includes extracting attributes of one or more elements in a webpage. Further, the method includes enabling a user to define steps for the one or more elements in the webpage. The method includes creating an interactive user guide in one or more formats. The method includes embedding the interactive user guide in-line with the webpage in the one or more formats. Further, the method includes publishing the interactive user guide on the webpage. Furthermore, the method includes enabling one or more users to access and contribute to the interactive user guide.

### CROSS-REFERENCE TO RELATED APPLICATION

This application claims the priority of Indian Provisional Patent Application No. 622/CHE/2014 filed on Feb. 10, 2014 the disclosure of which is incorporated herein in its entirety.

### TECHNICAL FIELD

The present invention relates to the field of extracting information from web browsers, and more specifically to the field of creating interactive guides using extracted information from a web browser and distributing the interactive guides across World Wide Web (WWW).

### BACKGROUND

The Internet has helped create rich sources of information accessible through a ubiquitous user interface called web browser. Examples of web browser include but are not limited to Internet Explorer, Safari, Chrome, Mosaic, Cello and Netscape. Today's web merely brings up individual web pages to individual users. The web pages are typically depicted as HTML “pictures” of data. Thus, the web page enables a user to browse information easily; however it is difficult to edit, analyze or manipulate the underlying data.

A WWW page is transmitted to a client as an HTML document. HTML is a structural language that is comprised of HTML elements that are nested within each other. An HTML document is a text file in which certain strings of characters, called tags, marks various regions of the document and assigns special meaning to the document. The regions in the HTML document are called HTML elements. Each element has one of a name and a tag. The HTML elements can have attributes specifying properties of the element.

Often, it is desired to provide definitions for the elements in the web page to assist the user navigating through the web page. For example, consider a scenario where a user is trying to fill up an online form. The user would require a step by step guide embedded along with the web page. Consider another scenario; the number of users seeking help for day to day web related problems has increased. For example, a user seeks help on ‘How to setup email account’. In the above mentioned scenario, it is desired to provide an in-line interactive guide displayed as a slideshow for the problems they are seeking on web. Furthermore, it is desired to provide a crowd sourced library with a plurality of help guides accessible by a plurality of users.

There exist documentation support tools for writing documentation for web pages. The tool provides help guides as a text document. Thus, a user has to read through the help guide and go back and forth across web-pages. The entire process is cumbersome and inefficient. The existing documentation support tool does not integrate the help guide with the web page. Further, the documentation support tools do not provide sequential display of element definitions as a slide show.

In another prior art, the method provides a video help guide for a web page. The prior art discusses a content development platform used to quickly record application navigations and capture conceptual information. The method includes capturing a plurality of screen shots of the web page and further presenting the screen shots as a video. However, the method does not provide an interactive guide defining each elements of the web page in a live format. Further, the method does not allow a plurality of users to contribute and publish help guides as a crowd sourced library.

In light of the foregoing discussion, there is a need for an efficient and simplified mechanism for providing interactive in-line guides to the users. Further, it is desired to enable users to create interactive guides displayed as a slideshow in a live format.

### SUMMARY

The above-mentioned problems are overcome by the present invention, which provides method to crowd-source creation of interactive help guides, mechanism to integrate across web for distribution and provide visual depiction of guides for interpretation as well as interactive step by step execution inline to website/web based product/services for which help is seeked.

An example of a method for providing an interactive user guide on a webpage includes extracting attributes of one or more elements in a webpage. Further, the method includes enabling a user to define steps for the one or more elements in the webpage. The method includes creating an interactive user guide in one or more formats. The method includes embedding the interactive user guide in-line with the webpage in the one or more formats. Further, the method includes publishing the interactive user guide on the webpage. Furthermore, the method includes enabling one or more users to access and contribute to the interactive user guide.

An example of a system for providing an interactive user guide on a webpage includes an element extraction module to extract attributes of one or more elements in the webpage. The system includes a pop-over module to define steps for the one or more elements in the webpage. The system includes an element identifier to map an element in the web page to an interactive user guide. Further, the system includes an executor module to publish the interactive user guide.

Another example of a system for providing an interactive user guide on a webpage includes a memory for storing instructions. The system includes a processor coupled to the memory and responsive to the instructions, wherein the processor is operable with a web browser and configured to extract attributes of one or more elements in the webpage, define steps for the one or more elements in the webpage, map an element in the web page to an interactive user guide, and publish the interactive user guide.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the disclosure, the disclosure is not limited to the examples depicted in the figures.

FIG. 1 illustrates a block diagram of an environment, in accordance with which various embodiments of the invention can be implemented;

FIG. 2 illustrates the block diagram of a browser embedded with an Interactive guide client, in accordance with one embodiment of the present invention;

FIG. 3 illustrates the block diagram of an interactive guide server, in accordance with another embodiment of the present invention;

FIG. 4 is a flow diagram illustrating a method for creating an interactive user guide, in accordance with another embodiment of the present invention; and

FIG. 5 is a flow diagram illustrating various methods included in the display of an interactive user guide, in accordance with one embodiment of the present invention.

### DETAILED DESCRIPTION OF THE EMBODIMENTS

Embodiments of the present disclosure described herein provide a method and system for contributing and distributing interactive guides across World Wide Web. A user is enabled to create an interactive guide for a webpage indicated by a URL. The user creates an interactive guide defining each element in the web page in a sequential manner. The interactive guide is stored and published in a community. A plurality of users can access the interactive guide corresponding to a URL from the community. The interactive guide is invoked automatically each time a user access the guide configured URL. Further, the interactive guide is displayed as a real time presentation to the user.

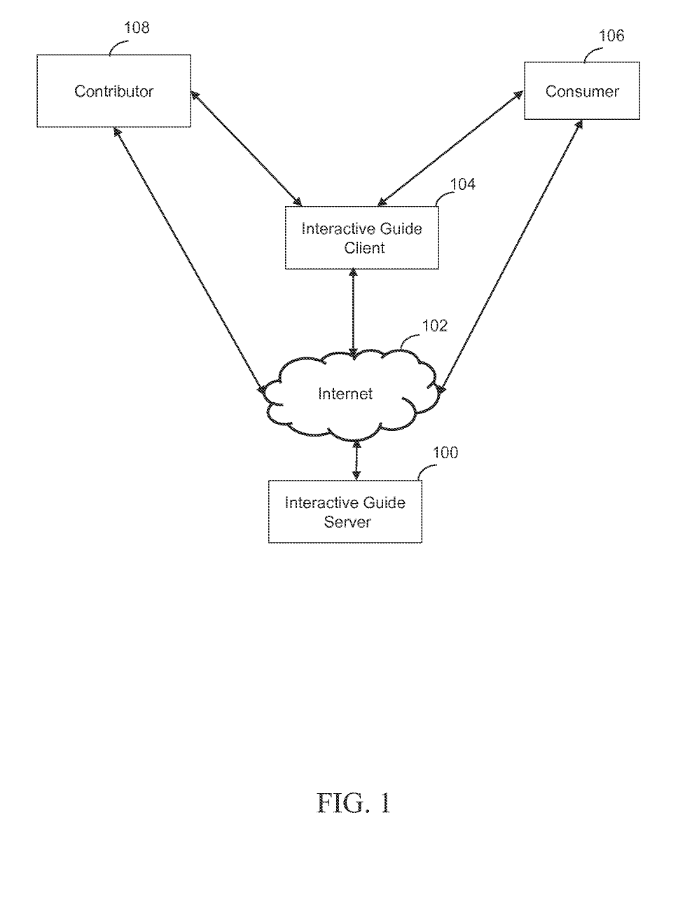

FIG. 1 illustrates a block diagram of an environment, in accordance with which various embodiments of the invention can be implemented. The environment includes an Interactive guide server 100, a contributor unit 108, a consumer unit 106, and an interactive guide client 104. The interactive guide server 100 communicates with interactive guide client 104 over internet 102. The contributor unit 108 is a diagrammatic representation of a plurality of users registered to create guides for web pages in the internet 102. Each user listed in the contributor unit 108 has a user profile with a list of published guides, and points allocated to the user. The interactive guide client 104 enables users in the contributor unit 108 to create, save and publish help guides for a plurality of URLs. The Consumer 106 is any user accessing the published guide for corresponding URLs. Both the consumer 106 of interactive guides and the contributors 108 of interactive guides communicate via the interactive guide client 104. The interactive guide client 104 is embedded in terminals supporting internet web browser. Examples of terminals include but not limited to Smart phones, Tablet, Personal Computer, and Laptops.

The Contributor 108 goes to webpage URL for which guide is required to be created, and initiates creation of new guide via the interactive guide client 104 installed in the browser. On starting a new guide, the contributor 108 is prompted to provide guide descriptions. Further, the contributor 108 provides options to initiate steps. The interactive guide server 100 stores the set of contents and guides provided by the contributor 108 and converts them into various formats such as videos, static articles, power point presentation, and help documents. Further, the interactive guide is published in a community, thereby allowing access to a plurality of users in the community. When the URL configured with a guide is invoked by a user, the interactive guide client 104 automatically displays the guide to the consumer 106 along with the web page. The guide is displayed in a live format as a power point presentation. Typically, a guide contains a sequence of steps defining one or more element in a web page. Each step in the guide includes at least one of a hyperlink, URL, video, image, and textual descriptions. The steps in the Interactive guide steps are sequenced similar to slide shows. In one scenario, the Interactive guide is embedded inside a webpage. In another scenario, the Interactive guide is visually displayed in a format similar to slide shows. A plurality of guides can be contributed by the contributor unit 108 to create a crowd sourced library in an online community. The crowd sourced library can be used by consumers to get inline interactive guide for the problems they are seeking on web.

In one instance, the interactive guide displays the consecutive steps in a guide in predefined order automatically. The subsequent steps are displayed automatically when the user hovers over the elements in the web page. In another instance, the consumer 106 can manually select the display of subsequent steps in the interactive guide.

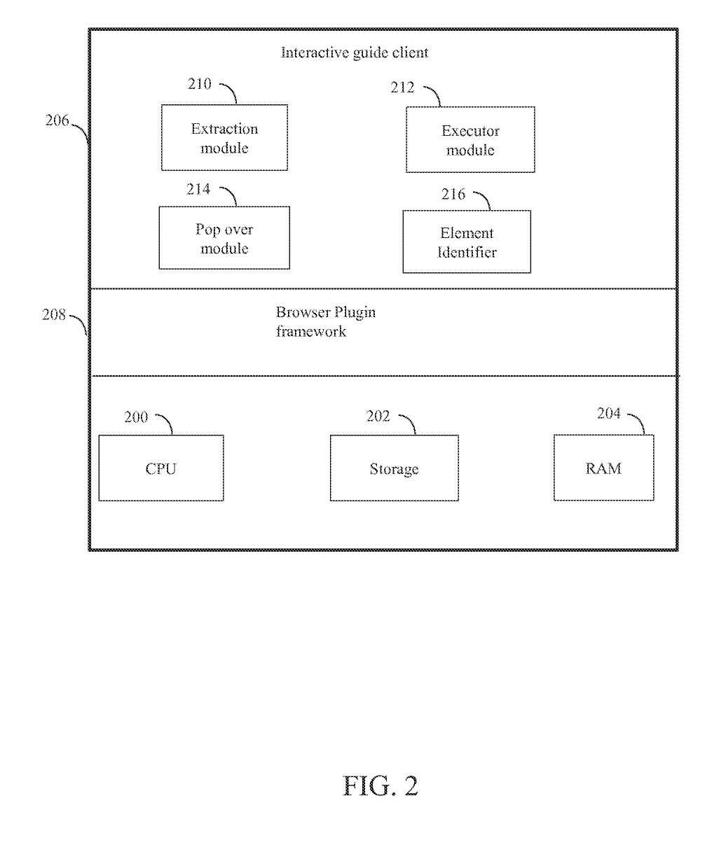

FIG. 2 illustrates the block diagram of a browser embedded with an Interactive guide client, in accordance with one embodiment of the present invention. An interactive guide client 206 enables a user to create interactive guides for a web page and to embed the interactive user guide in-line with the web page in one or more formats. The interactive guide client 204 is typically deployed in terminals having a Central Processing Unit (CPU) 200, a storage module 202 and a RAM 204.

A browser plugin framework 208 provides a monitoring and management console which allows users to browse and to interact with any kind of objects. The browser plugin framework 208 is hereinafter referred to as plugin framework 208. The plugin framework 208 is generic framework configured using a specific XML DTD grammar. Further, the plugin framework 208 is extended by developing plug-ins compliant with the Application Programming Interfaces (API) defined by Browser framework. Furthermore, the plugin framework is defined to provide an entity the ability to browse a set of resources. Further, the Interactive guide client 206 is an extensible plugin embedded into the plugin framework 208 of a web browser.

The Interactive guide client 206 includes an Extraction module 210, an Executor module 212, a guide evaluator 214, and an element identifier 216. The contributor opens the URL for which interactive guide is to be made. Further, the contributor invokes the interactive guide client 208 plugin installed in the browser. The interactive guide client 208 enables a user to define a step by step flow for the elements in the URL. The steps defined include at least one of a graphical description, an image description, a textual description, and a combination thereof. When a contributor initiates a new step in the interactive guide client 208, element identifier 216 identifies underlying html element been referred by mouse pointer. Examples of the html elements include but are not limited to hyperlink, buttons, frames, tables, rows, columns, images, div, span, headers, and footers. Further, the element identifier 216 highlights the element referred to by mouse pointer.

On selection of a web element, the extraction module 210 captures the image which includes selected web element as well as surrounding section. The extraction module extracts properties of the HTML element and surrounding element information including identifiers, CSS properties, ID of the element, hierarchies, attributes, and position of the web element. Further, the extraction module 210 prompts the contributor for providing a description of the step after capturing properties of the HTML element.

The contributor provides description and further updates other options such as define if step is optional or mandatory, and adds additional notes. The contributor continues the above process of selecting web element and provides description for each web element until all steps are created for the process in the URL. Once all steps created, the contributor can save the guide in the interactive guide server.

The pop over module 214 provides pop-up windows to create various steps in guide. For each element selected in the web page, a pop-over window is generated. The pop-over window enables the user to provide definitions for one or more elements in the web page. Each web page is written in a plurality of different languages and the web page format varies from one to another. The pop over module 214 is designed to display the pop ups for each web page consistently in a specific orientation. Further, the plurality of definitions created for one or more elements is processed by the executor module 212.

The executor module 212 enables a user to save the definitions for one or more elements to create the interactive user guide. The interactive user guide includes a plurality of steps with definition of one or more elements in a sequence. Further, the executor module 212 invokes the publishing of a respective guide associated with a loaded web page. The executor module 212 overlooks the entire guide and decides the format for display of guide based on the actions defined by the user. The user actions defined include one of hovering over at least one or more elements in the webpage, clicking on one or more elements in the webpage, and selecting a next button in the interactive user guide.

The executor module 212 retrieves the entire guide associated with a loaded web page with the help of element identifier 216. The element identifier 216 also performs the function of mapping the element in the loaded web page with previously stored element definitions in the interactive guide server. The element identifier 216 analyses properties of each element in the interactive guide server. Further, the element identifier maps the loaded web page to an element definition in the interactive guide server. On finding a match with the element, the element identifier retrieves the interactive guide corresponding to the loaded web page. Further, the interactive guide is stored in a client cache for ease of access for the executor module 212.

The executor module 212 provides sequential display of the steps within a guide in one or more formats. The formats include at least one of embeddable script, videos, and slideshows. Further, the pop-over module 214 pushes the executor 212 to parse the subsequent steps and display to consumer. The executor module 212 embeds the interactive user guide in-line with the webpage. Thus, the executor module 212 controls the entire process of guide display.

The CPU 200 resides in a terminal and includes an integrated electronic circuit for processing and controlling functionalities of the browser. Examples of terminal include one of laptop, desktop, smart phone, and tablet. The terminal further includes the storage module 202 coupled to the browser plugin framework 206 for storing information to be used by the CPU 200. The storage module 202 is a memory and can be used for storing any temporary information required. The storage module 202 is a storage unit, such as a magnetic disk or optical disk.

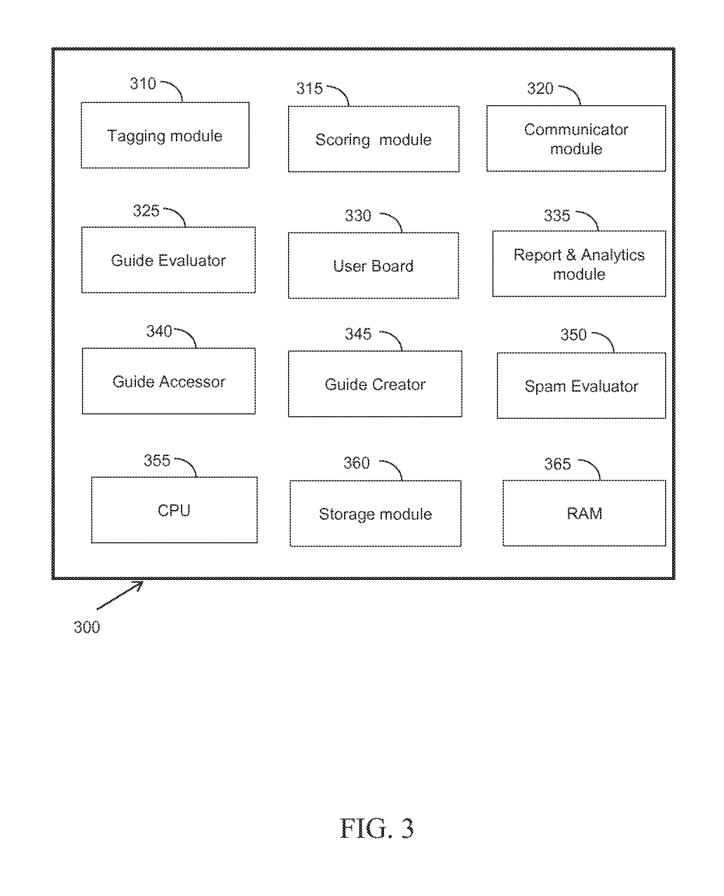

FIG. 3 illustrates the block diagram of an interactive guide server, in accordance with one embodiment of the present invention. The interactive guide server 300 has three-tier architecture. The interactive guide client enables a user to create interactive guides and such guides created are stored in the interactive guide server 300. The interactive guide server 300 includes a tagging module 310, a scoring module 315, a communicator module 320, a guide accessor 340, and a guide creator 345 to aid in guide creation. The interactive guide server 300 further includes a spam evaluator 350, a CPU 355, a storage module 360 and a RAM 365.

The interactive guide server 300 contains a plurality of guides created by a plurality of users. The plurality of guides is maintained as a crowd sourced library with in an online community. Plurality of users registered with the online community can contribute guides to the crowd sourced library. Further, one or more registered users can access and modify the published guides. A user profile is created for each user registered in the online community and the user profile is further maintained in the interactive guide server 300. Each user profile is mapped to a plurality of guides created by respective users. Points are allocated to each user based on their guide contributions. The execution steps, modifications and points associated with a user profile is managed and maintained on a user board 330. User board 330 helps in encouraging more contributors and further maintains the overall quality and health of interactive guide system.

A guide evaluator 325 automatically evaluates the guides created for its health periodically. The guide evaluator 325 runs auto-test and marks any guide failing to identify a web element in the configured web page URLs. A spam evaluator 350 analyses and stores the deleted guides and guides marked as spam by the user. Further, the test failed guides along with manually marked spam guides are listed in the user board 330. The contributors can earn more points in their respective user profile by modifying and correcting the failed guides. A report and analytics module 335 generates regular reports based on contribution of different contributors to identify leaders from the user board 330. A communicator module 320 communicates the reports to contributors via email, social network and other communication modes.

The interactive guide client enables a user to create a step by step interactive guide for the web elements in a webpage pointed to by the URL. For creation of a web page, snap shots of the web element along with the properties of the web element are extracted by the interactive guide client. On publishing the guide, the interactive guide client passes on all the captured information such as steps definitions, images, descriptions, additional information and notes to the interactive guide server 300 over internet. On receiving all the details of guides, the Guide creator 345 merges each snapshot of web element with respective descriptions to create slides. Further, the Guide creator 345 arranges all the created slides in sequence to prepare a slideshow. The Guide creator 345 also generates scripts and archives along with the generated slides and further stored in the storage module 360 of the interactive guide server 300.

Interactive guide server 300 is configured in a cluster environment, so every stored guide gets replicated across two or more servers as defined in the cluster configuration for better reliability & availability. Tagging module 310 provides a mechanism to categorize each guide into different domains based on keywords, similarities and thereby provides easy navigation. Further, Tagging module 310 assists the user in identifying related guides, following any specific topic (tag) and receive periodic communications on updates, additions, and modifications in guides of followed topic. Further, the contributor with more points has the privilege to use tagging and to view enhanced reports.

The plurality of guides created by the contributor can be accessed by a consumer by different methods using the guide accessor 340. In a method, the consumer access guide to get an embeddable frame which can be integrated in any webpage. The integration of embeddable frame enables any next level consumer visiting the corresponding webpage to view the guide in slide show format.

In another method, the consumer gets embeddable scripts for any specific guide to include in their webpage source. On integrating embeddable scripts inside webpage, the guide can be executed by consumers within the page. Consumer can invoke the guide corresponding to a first URL by one of clicking on the executable guide during slideshow, and triggering the guide by integrated embeddable scripts. When a guide is invoked, the embeddable script communicates with the interactive guide server to validate if the interactive guide client is installed by consumer. If the interactive guide client is not installed in the consumer device, the consumer is requested to install the interactive guide client before proceeding with execution of guide.

During installation of the interactive guide client, the executor module in the interactive guide client communicates with guide accessor 340 to fetch the details of guide. The Guide accessor 340 fetches details of the corresponding guide from storage module 360 based on the value indicated by scoring module 315. The scoring module 315 analyses the plurality of guides stored in the storage module 360 and retrieves the guide with a matching score. Further, the Guide accessor 340 provides the guide details corresponding to the first URL to the executor after temporarily caching them in the RAM 365 for better performance.

Various embodiments are related to the use of a terminal for creating and publishing interactive guides in a browser. In one embodiment, the techniques are performed by the CPU 355 using information included in the ROM 365 and the storage module 360.

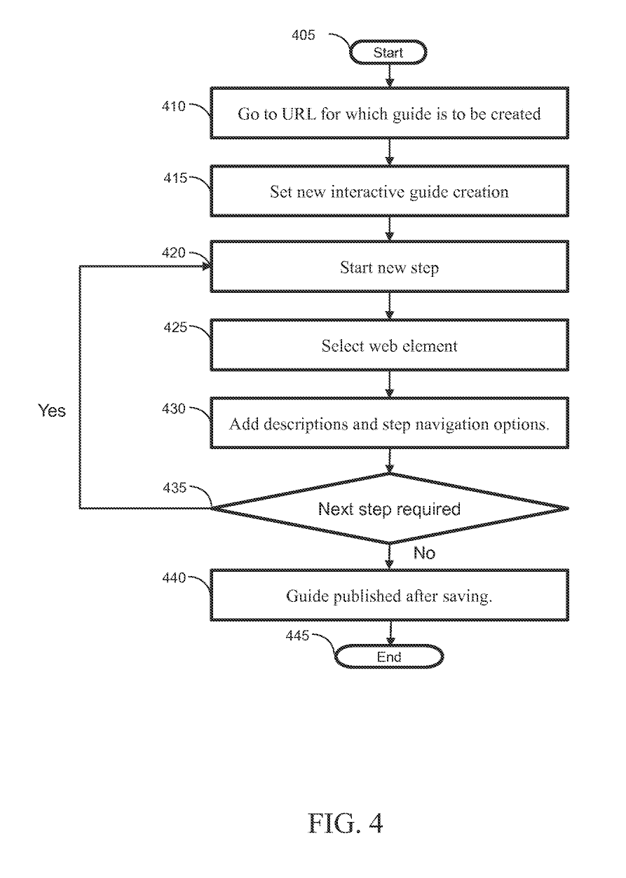

FIG. 4 is a flow diagram illustrating various methods in the creation of an interactive user guide, in accordance with one embodiment of the present invention. The flowchart begins at step 405.

At step 410, a contributor goes to webpage URL for which guide is required to be created. The guide can be created for browser applications in a device installed with an interactive guide client. Examples of the device include but are not limited to laptops, smart phone, desktop, and tablet.

At step 415, the contributor initiates creation of a new guide via the interactive guide client. The interactive guide client is a plugin embedded in the browser plugin framework.

At step 420, a new step is initiated for the guide. The contributor selects an element in the web page and invokes the interactive guide client plugin to generate a pop-over window to create the new step.

At step 425, a web element is selected by the contributor. The extraction module captures the image which includes selected web element as well as surrounding section.

At step 430, the contributor provides description and updates other options like whether step is optional or mandatory, and additional notes.

At step 435, the executor module checks if a ‘next step’ button is selected by the contributor. Accordingly, a new pop-over window is displayed for defining another element in the web page. If next step is required, the process repeats from step 420, else step 440 is performed.

At step 440, the guide is published after saving in the interactive guide server. The interactive guide displays the interactive guide when the web page with a configured guide is accessed by the user.

The flowchart ends at step 445.

In one embodiment, a user invokes an application embedded in a web browser of a client device. The application is an interactive user guide plugin. Using the application, a user can extract attributes of one or more elements in a webpage. The user can create an interactive user guide in one or more formats. The one or more formats includes at least one of slideshow, article, video, button, and a widget. In one example, the application can create a plurality of slides. Further the plurality of slides are merged and presented as a slideshow.

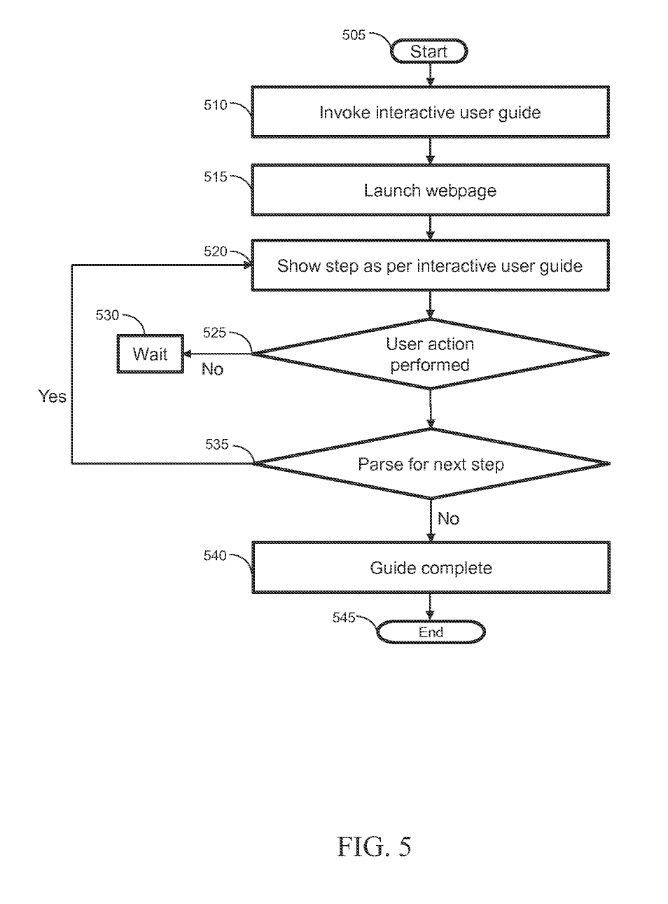

FIG. 5 is a flow diagram illustrating various methods in the display of an interactive user guide, in accordance with one embodiment of the present invention. The flow chart begins at step 505.

At step 510, a user invokes an interactive guide client in a browser of a user device. The interactive guide client is embedded within a plugin framework of the browser. The user device includes one of but not limited to a smart phone, a personal digital assistant, a smart TV, and a tablet.

At step 515, the user launches a webpage using the browser installed in the user device. The webpage consists of a plurality of elements for the allowing the navigation of the user through the webpage. The plurality of elements includes one of hyperlinks, buttons, frames, tables, rows, columns, images headers, footers and a combination thereof. Upon user selection one of the plurality of elements gets highlighted. Further, an element extractor, within the interactive guide client, extracts a plurality of element attributes related to the highlighted element. The interactive guide client maps the plurality of attributes to one of a plurality of element attributes stored in an interactive guide server. The interactive guide client retrieves an interactive user guide from the interactive guide server.

At step 520, the interactive user guide publishes the interactive user guide in a step by step sequence.

At step 525, the element extractor parses the action performed by the user. The action performed by the user is one of selecting an option for displaying subsequent steps in the interactive help guide, and hovering over at least one of a plurality of elements in the webpage. If an action is performed step 535 is performed, else step 530 is performed.

At step 535, the element extractor parses for the next step to be published. In case the interactive user guide has no further steps to publish step 540 is published, else the flow repeats from step 520.

At step 540, the completed interactive user guide is published and saved in the interactive guide server. Further, the guide is automatically launched in a live format while accessing the URL.

The flow chart ends at step 545.

In one embodiment of the present invention, the interactive guide is created by means of crowd sourcing. In crowd sourcing, a plurality of users contributes a plurality of guide to a community. The plurality of guides is published in the community, thereby allowing customers registered in the community to access the plurality of guides. Each user registers into the interactive guide community with a using profile. In another embodiment of the present invention, the interactive guide is created by individuals owning respective websites, web based products and services.

In another embodiment of the present invention, the interactive guide client supports the creation and publishing of interactive guides in a plurality of applications. The plurality of applications include corporate training guide over intranet, browser applications, mobile browser applications and mobile applications.

In the preceding specification, the present disclosure and its advantages have been described with reference to specific embodiments. However, it will be apparent to a person of ordinary skill in the art that various modifications and changes can be made, without departing from the scope of the present disclosure.

Accordingly, the specification and figures are to be regarded as illustrative examples of the present disclosure, rather than in restrictive sense. All such possible modifications are intended to be included within the scope of the present disclosure.

What is claimed is:

1. A method of providing an interactive user guide on a webpage, the method comprising:
extracting attributes of one or more elements in a webpage;
enabling a user to define steps for the one or more elements in the webpage;
creating an interactive user guide in one or more formats;
embedding the interactive user guide in-line with the webpage in the one or more formats;
publishing the interactive user guide on the webpage; and
enabling one or more users to access and contribute to the interactive user guide.

2. The method as claimed in claim 1 and further comprising:
storing the attributes in an application server.

3. The method as claimed in claim 1, wherein extracting attributes of one or more elements in a webpage comprises:
invoking an application embedded in a web browser of a client device, wherein the application is an interactive user guide plugin.

4. The method as claimed in claim 3, wherein the application performs steps of:
creating a plurality of slides;
merging the plurality of slides; and
preparing a slideshow based on merged slides.

5. The method as claimed in claim 1, wherein the steps defined are at least one of a graphical description, an image description, a textual description, and a combination thereof.

6. The method as claimed in claim 1, wherein the attributes comprises at least one of a name of the element, position of the element, parent of the element, hierarchy of the element, Cascading Style Sheet (CSS) file properties of the element, and a combination thereof.

7. The method as claimed in claim 1, wherein the one or more elements are at least one of hyperlinks, buttons, frames, tables, rows, columns, image headers, footers and a combination thereof.

8. The method as claimed in claim 1, wherein publishing further comprises:
extracting attributes from the webpage;
mapping the attributes stored in an application server with one of the attributes extracted from the web page;
identifying the interactive user guide for the webpage; and
retrieving the interactive user guide from the application server.

9. The method as claimed in claim 1, wherein the one or more formats comprises at least one of slideshow, article, video, button, and a widget.

10. The method as claimed in claim 1 and further comprising:
defining user actions for displaying each step in the interactive user guide, wherein user actions is one of hovering over at least one or more elements in the webpage, clicking on one or more elements in the webpage, and selecting a next button in the interactive user guide.

11. A system for providing an interactive user guide on a webpage, the system comprising:
an element extraction module to extract attributes of one or more elements in the webpage;
a pop-over module to allow a user to define steps for the one or more elements in the webpage;
an element identifier to map an element in the web page to an interactive user guide; and
an executor module to publish the interactive user guide.

12. The system as claimed in claim 11, further comprising:
an application server to convert the interactive user guide into one or more formats, wherein the one or more formats comprises at least one of slideshow, article, video, button, and a widget.

13. The system as claimed in claim 11, wherein the pop-over module displays the interactive user guide based on user action.

14. The system as claimed in claim 11, wherein the executor module performs step of:
retrieving the interactive user guide stored from the application server;
embedding the interactive user guide in-line with the webpage in one or more formats; and
publishing the interactive user guide based on user action.

15. The system as claimed in claim 11, wherein the element identifier perform steps of:
mapping the attributes stored in an application server with one of the attributes extracted from the web page; and
identifying the interactive user guide for the webpage.

16. The system as claimed in claim 11, wherein the element extractor performs steps of:
extracting the attributes of one or more elements in the webpage; and
storing the attributes in the application server.

17. A system for providing an interactive user guide on a webpage, the system comprising:
a memory for storing instructions;
a processor coupled to the memory and responsive to the instructions, wherein the processor is operable with a web browser and configured to:
extract attributes of one or more elements in the webpage;
define steps for the one or more elements in the webpage;
map an element in the web page to an interactive user guide; and
publish the interactive user guide.

18. The system as claimed in claim 17, further comprising:
an application server to convert the interactive user guide into one or more formats, wherein the one or more formats comprises at least one of embeddable script, videos, and slideshows.
